(19) United States
(12) Patent Application Publication
(10) Pub. No.: US 2005/0113974 A1
(43) Pub. Date: May 26, 2005

(54) Cooperative robot system and navigation robot system

(75) Inventor: Miwako Doi, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/954,100

(22) Filed: Sep. 30, 2004

(30) Foreign Application Priority Data
Sep. 30, 2003 (JP) 2003-342537

(51) Int. Cl. G06F 19/00

(52) U.S. Cl. 700/245

(57) ABSTRACT

A cooperative robot system includes a takeover determining section which determines whether or not another robot takes over an executed task, a communication section which transmits a takeover information to the another robot when the takeover determining section determines to take over the executed task, a media converting section which converts the takeover information into at least one of linguistic expression and non-linguistic expression, a media generating section which generates control information which represents a converted result of the media converting section in the linguistic or non-linguistic expression, and a media setting section which exhibits a takeover content of the takeover information represented in at least one the linguistic expression and the non-linguistic expression.

### CROSS-REFERENCE TO RELATED APPLICATION

This application is based upon and claims the benefit of priority from the prior Japanese Patent Applications No. 2003-342537 filed on Sep. 30, 2003; the entire contents of which are incorporated herein by reference.

### BACKGROUND OF THE INVENTION

1. Field of the Invention

This invention relates to cooperative robot system, in which plural robots work together to perform a task, for examples, navigation robot, and predictive robot which provides predictive information, such as weather forecast, based on information gathered via internet.

2. Description of the Related Art

In a related art, many robots (a robot which walks on two legs, a robot for entertainment, a robot which speak plural languages, a robot which looks after a house, and a robot which performs personal identification by voice recognition and face image etc.) are developed. The robots provide an information from Internet search when the robots response to a question which a human being asks. When a human being speaks to the robots, the robots can recognize his voice and searches information, as opposed to information search by using personal computer or cellular phone. The robots employ to detect a sound which does not continue more than a predetermined time, so that the robots can determine whether or not to speak to.

In a daily life, there is a need to predictively provide a local information before a human being recognize the local information. For example, in case that it seems to rain suddenly, they may pick up their laundry, and in case that a family member is on the way to home from a station, they may prepare meal. Thus, to provide predict information is a Push type provision of information which is different from Pull type provision of information as related art. In many case of the Pull type provision of information, the service is provided by a mail of the personal computer and the cellular phone. However, in the related art, the robots read the mail only when a user instructs the robots to read the mail, but does not read the mail on their own initiative.

In the related art, one robot is designed to perform station service and a cleaning all by itself. (Please see paragraph [0026], FIG. 1 in JP-A-8-329286) Many robot can work in a plane in a home, a station, and a hospital. There is a problem that the robots become expensive and large in size, if the robots can go up and down stairs.

To solve the problem, when a robot and termination device which a user have work together to perform a guide, a takeover information is informed by the robot or a character which is displayed on the termination device. (Please see paragraphs [0064]-[0065] FIG. 8 in JP-A-2001-116582)

Thus, if one robot has many functions to perform, the one robot become large in seize and expensive. To solve the problem, plural robots work together. However, there is a problem that how assigning tasks among the plural robots are controlled to determine, and that it is difficult for a user to find whether or not the assigning tasks are shared after determining the tasks.

### SUMMARY OF THE INVENTION

It is an object of the invention to provide a cooperative robot system which can confirm that robots of the system can easily take over a task with safe, so that the system can give a safety to a user.

According to one aspect of the invention, there is provided with the cooperative robot system including: a takeover determining section which determines whether or not another robot takes over an executed task; a communication section which transmits a takeover information to the another robot when the takeover determining section determines to take over the executed task; a media converting section which converts the takeover information into at least one of linguistic expression and non-linguistic expression; a media generating section which generates control information which represents a converted result of the media converting section in the linguistic or non-linguistic expression; and a media setting section which exhibits a takeover content of the takeover information represented in at least one the linguistic expression and the non-linguistic expression.

According to another aspect of the invention, there is provided with the cooperative robot system in which a verification section verifies whether or not the another robot which takes over the executed task is correct.

The takeover between the robots can be significantly and easily confirmed the takeover by such a form that people take over with each other, not by an usable form using by internet, so that the cooperative robot system can give a great safety to the users.

Further, in the related art, only a person who have knowledge with respect to computer and network or a person who have a precise will can conform the takeover between the robots. However, users can conform without burden, the effective is very large.

### BRIEF DESCRIPTION OF THE DRAWINGS

FIG. 1 is a block diagram showing outline of the first embodiment;

FIG. 2 is a flow chart showing a takeover processing of the first embodiment;

FIG. 3 is one example of the takeover protocols of the first embodiment;

FIG. 4 is one example of the protocol which a robot system has in the takeover protocols.

FIG. 5 is one example of the protocol which another robot system has in the takeover protocols;

FIG. 6 is a flow chart showing a processing when the takeover event occurs;

FIGS. 7A, 7B, 7C and 7D are explanation for face detection by the robot system;

FIG. 8A shows normalization pattern of the face image;

FIG. 8B shows characterized vector of the face image;

FIG. 9 shows realization image according to the second embodiment;

FIG. 10 is a block diagram showing outline of the second embodiment;

FIG. 11 is a flow chart showing generation processing of the path information;

FIGS. 12A, 12B, and 12C are examples of the construction information;

FIGS. 13A, 13B, and 13C are examples of the path information;

FIG. 14 is one example of guide display of the search path;

FIG. 15 is one example of guide in the 3 dimensions premises;

FIG. 16 is one example of the takeover protocol which the robot system has in the takeover protocols of the second embodiment; and

FIG. 17 is one example of path network for guide in the premises.

### DETAILED DESCRIPTION OF THE EMBODIMENTS

The embodiments will be described herein below by referring the accompanying drawings.

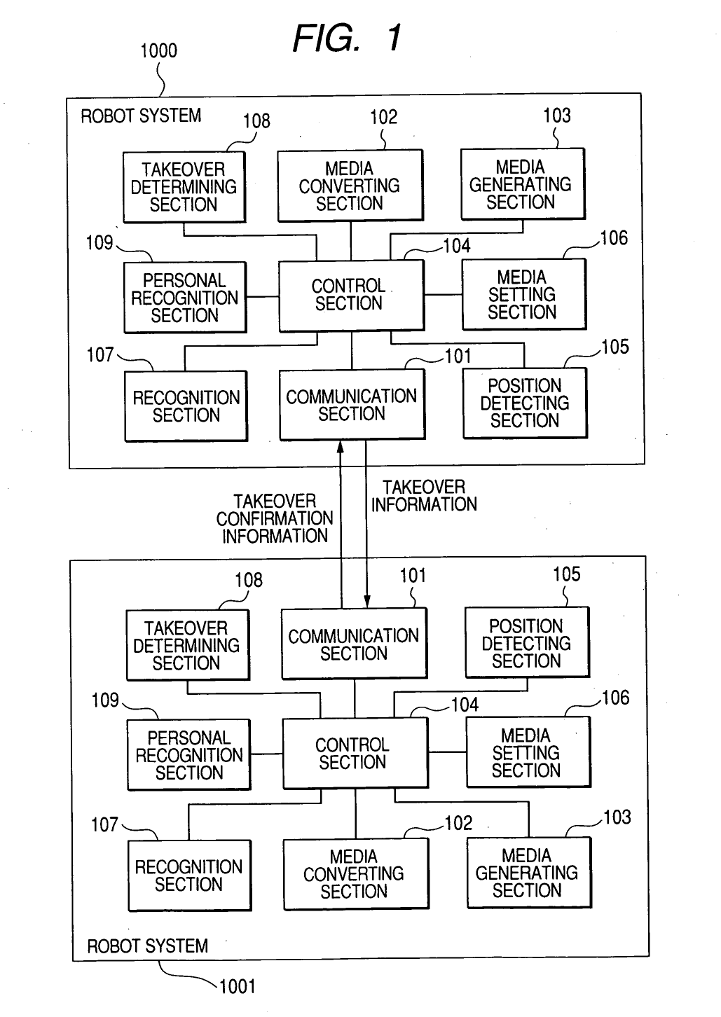

FIG. 1 shows overview of block diagram according to the first embodiment which relates to a system of takeover among robots of the cooperative robot system. In FIG. 1, the cooperative robot system is configured by pet type robot 1001 which includes movable part and mainly functions personal communication and crime prevention/security type robot system 1000 which performs personal recognition to control to allow someone in room at entrance, door, and a reception desk etc.

When communication such as takeover is performed between the robot systems (1000, 1001), the takeover is transmitted and received by using wireless line such as Bluetooth, wireless LAN. In the communication, an information is transmitted and received via communication section 101 of each robot system and the transmitted/received information is converted into at least one linguistic expression and non-linguistic expression. Herein, “the non-linguistic expression” is one of communication such as behavior and gesture. In the robot systems, the non-linguistic expression corresponds a display section or expression to human beings by the movable part of the robot system.

As a result of converting the information by a media converting section 102, media generating section 103 generates a way of expression (control information) which the robot system can produce as a media including at least one among voice, sound, and gesture. A media setting section 106 includes at least one among speaker, display and a movable part which assimilates such a shape as hand, tail, ear, eye, and leg to set the result produced by the media generating section. A recognition section 107 correctly recognizes an opponent to take over. A position detecting section 105 detects a position information which is required to determine whether or not the opponent is within area in which the robot systems position to take over. A takeover determining section 108 determines whether or not the takeover is appropriate on the basis of the position information detected by the position detecting section 105. A personal recognition section 109 performs to recognize someone in family. A control section 104 controls the constituent sections.

The position detecting section 105 can detect a position information (latitude and longitude) out of doors by GPS (Global Positioning System) based on a position of synchronous satellite In case of cellular phone such as PHS, the position detecting section can detect which of cell station the position information is within by amplitude of electromagnetic wave from the cell station. In case of indoors, the position detecting section can extracts a present position from start points, if a map is previously prepared in the position detecting section. In another case of indoors, RF (Remote Frequency) tags are previously set in plural point of the indoors, and the position detecting section includes a map indicating each position of RF tags and each ID of the RF tags, the position detecting section can detect the position of RF tags by detecting ID of the RF tags. Two dimension Bar-code is set at door, and the bar-code is scanned, the position detecting section can detect the position information by ID of the bar-code by referring a map which is previously prepared.

In a personal recognition section 109, there are some personal recognition method such as recognition by face image taken by camera, recognition by iris imaged by camera, voice recognition, and recognition by finger print. Hereinafter, the personal recognition section performs the personal recognition by the face image for purpose of illustration.

In addition to the above-described construction, the pet type robot system 1001 which mainly functions the personal communication includes a movable section 110 (not shown) such as wheel and leg parts and can move by the movable part.

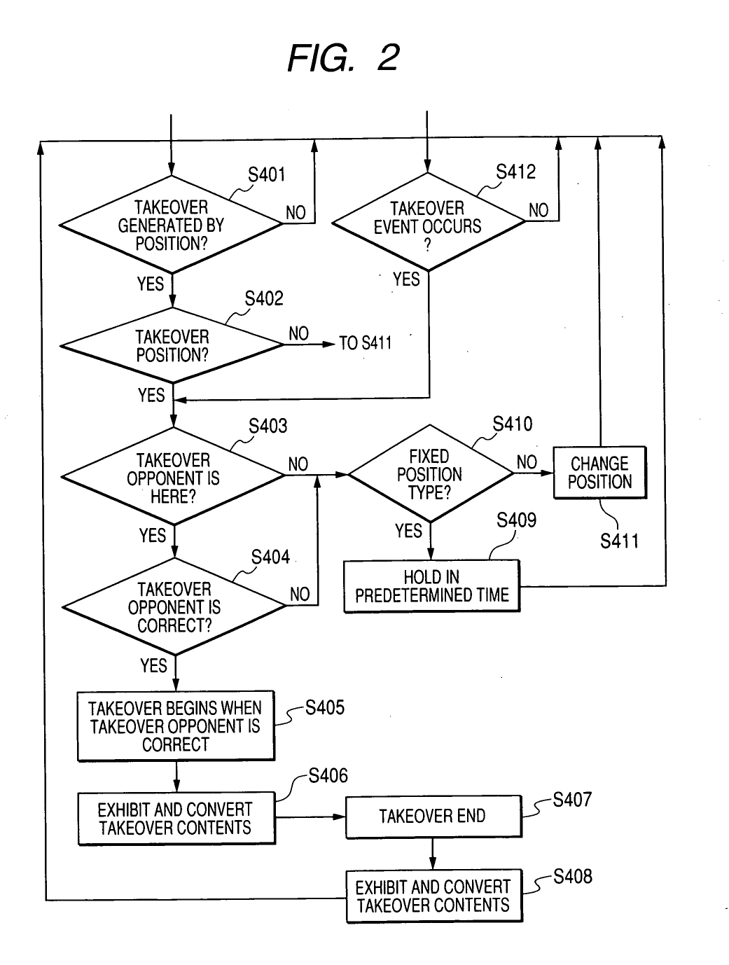

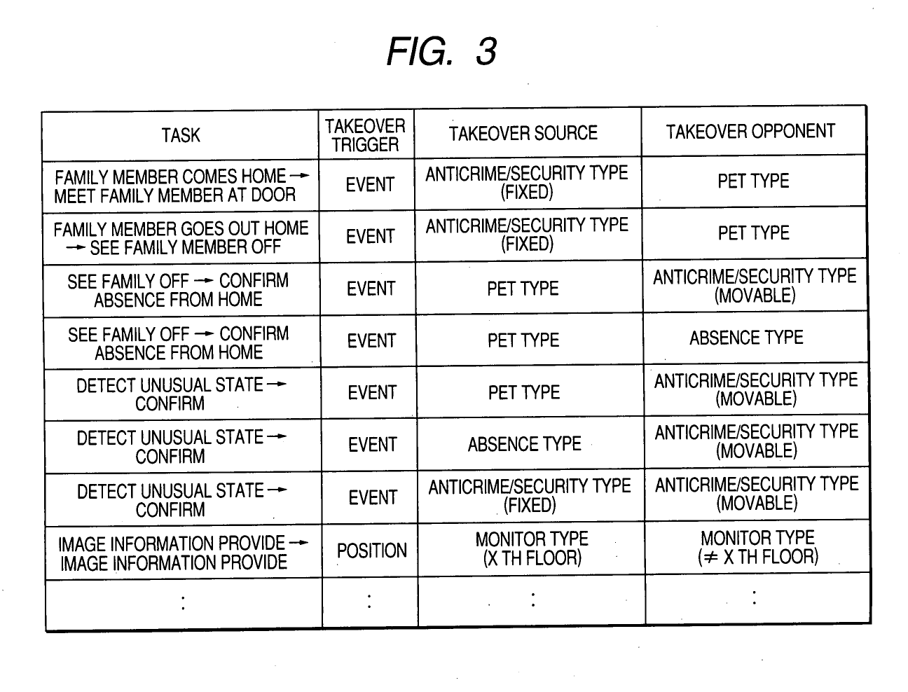

FIG. 2 shows one example of flow chart of takeover processing in the system as shown in FIG. 1. Two takeover cases are assumed in the example. One case is takeover when a takeover event generates. The other case is a takeover by a position. FIG. 3 shows the differences between the takeover by the position and the takeover by the event and protocol of the robots with respect to the destination of the takeover and the source of the takeover. In FIG. 3, each task has kinds of takeover trigger by the position or event, a classification of robot function as the source of the takeover, and a classification of robot's function as the destination of the takeover.

For example, there are, as the takeover by the event, to greet a member of family and to confirm homecoming of the member, to detect and confirm unusual situation, and an incoming mail. On the other hand, there are, as the takeover by the position, to provide image information when someone moves from first floor to second floor, and to change a navigator when someone being navigated moves in a floor guide.

For example, in the first embodiment as shown in FIG. 1, it will be explained by a case that the crime prevention security type robot 1000 confirm that father (the family member) comes to home and meet him at the door, and the pet type robot 1001 takes over a task from the robot 1000. In processing flow as shown in FIG. 2, it is determined whether or not the takeover is generated by the event or the position. Step S401 determines whether or not the takeover is generated by the position. Step S412 determines whether or not the takeover is generated by the event.

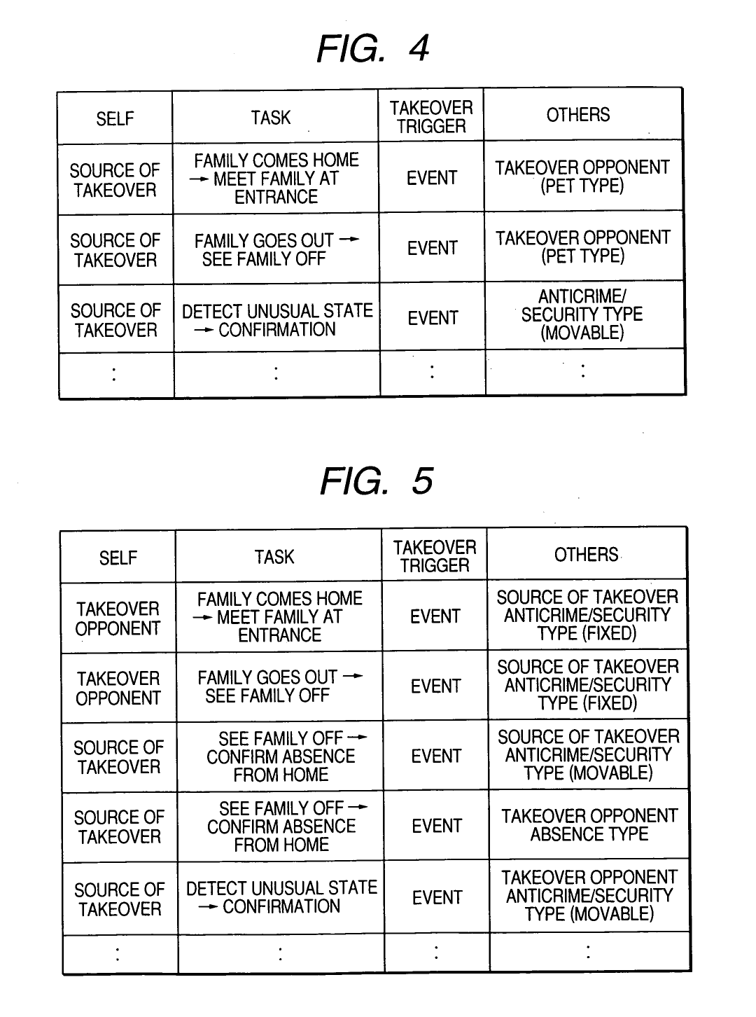

In example of FIG. 1, “to confirm a family member coming home and to meet the family member”, the crime prevention security type robot 1000 has a takeover determining section 108 which is crime prevention security type robot in a takeover protocol as shown in FIG. 3 and which stores a protocol with respect to fixed type as shown in FIG. 4. In FIG. 4, the protocols of the crime prevention security type robot (fixed) within the protocols showing SELF is a source of the takeover or a destination of the takeover, kind of the takeover task, kind of takeover trigger, and the opponent of the takeover task (OTHERS) is a source of the takeover or a destination of the takeover, is set out and stored. FIG. 5 shows a protocol with respect to the pet type robot which is stored in the takeover determining section 108 of the pet type robot 1001.

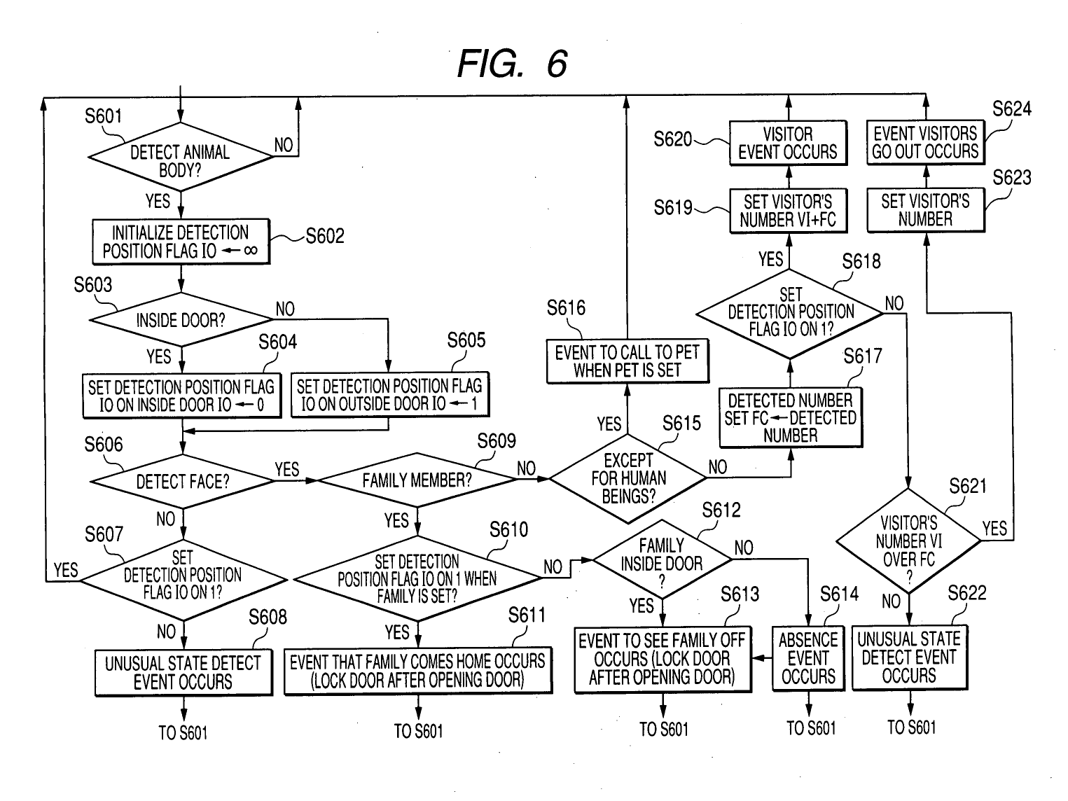

FIG. 6 shows a processing of generation of the takeover event around a detection of animal body extracting from processing of the crime prevention/security type robot 1000. A camera of the personal recognition section 109 detects an animal body. (Step S601) The camera inputs a face image and is configured by CCD camera and light member. Image taken by CCD camera or CMOS camera is digitalized by A/D converter such as image input board and stored in a memory. The image memory may be on the image input board and may be on the memory of the computer.

Detection position flag IO is initialized when the animal body is detected, since the following processing in case that the detected position of the animal body is inside door is different from that in case that the detected position of the animal body is outside door. (Step S602) whether or not the detected position of the animal body is inside door is determined (Step S603). If the detected position is inside door, the detection position flag IO is set to be a value for inside door (the value is zero in this case). Otherwise, if the detected position is outside door, the detected position flag IO is set to be a value for outside (the value is 1 in this case). The detection position is not limited in inside/outside door. The setting of the detected position flag IO is more precise and stepped. Hereinafter, to explain easily, the processing focuses on inside door (IO=0) and outside door (IO=1).

Further, the detected animal body is determined more precisely; the detection of the face image is performed (Step S606). An extraction of face area is to detect the face area or head area from images which are stored in the image memory of the personal recognition section 109.

There are some methods of extracting the face area. For example, in case of color image, the extracting method is performed by color information. Color image is converted from RGB color space into HSV color space and the face area or head hair area is divided by area division while using the color information such as hue and color saturation. The partial divided area is detected by area combined method. In another method of extracting the face area, a template for face detecting which is previously prepared is moved in the image to calculate relative value. An area including the highest relative value is detected as a face area. Instead of the relative value, there are some methods by using Eigenface method or partial space method to calculate a distance or a degree of similarity, and then to extract an area having the minimum distance or an area having the most degree of similarity. There is another way such that a near infrared ray enters and an area corresponding to the subject face is extracted by the reflected near infrared ray. Herein, another way of extracting the face area may be adopted.

Whether or not the extracted face area is a face or not is determined by detecting a position of eye from the extracted face area. The detection method may be performed by using pattern matching as well as the face detection method, or the detection method my be performed by extracting face characteristic points such as eyes, nares, and end of mouth from moving images including those described in “Extraction of face characterized points by combination of shape extraction and pattern verification” IEEE, vol. J80-D-2, No. 8, pp. 2170-2177 (1997) the entire contents of this reference being incorporated herein by reference. Further, another extracting method may be adopted.

An area in predetermined area and shape is extracted from the position of the face parts and the position of the face area on the basis of the extracted face area and face parts detected from the face area. A contrasting density information as a recognition characteristic amount is extracted from the input image. Two parts are selected from the detected face parts. If the line connecting the two parts is within the extracted face area in a predetermined ratio, the extracted face area is converted into m×n area as normalization pattern.

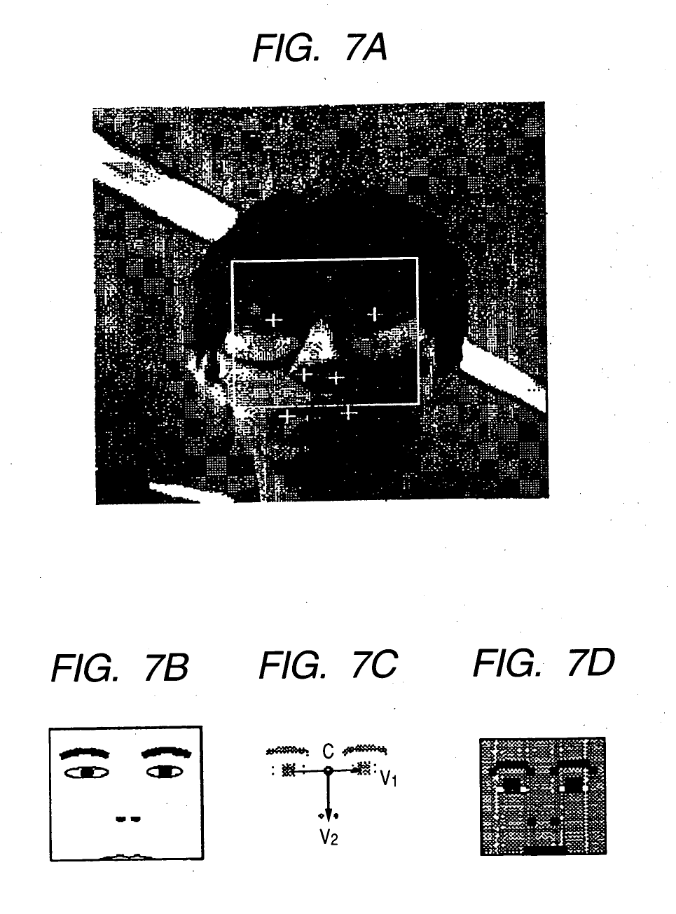

FIGS. 7A and 7B shows an example of both eyes as face parts. In FIG. 7A, face area extracted from face image take by image input device is drawn by white rectangle shape and detected face parts are drawn to overlap by white cross-like Figure. In FIG. 7B, extracted face area and face parts is drawn by pattern diagram. In FIG. 7C, if the distance from the center point of the line connecting between right eye and left eye to each part is a predetermined ratio, the face area is converted into the contrasting density information, and become m×n of image elements as the contrasting density information as shown in FIG. 7D. A pattern as shown in FIG. 7D is regarded as normalization pattern. If such a pattern is extracted, a face is detected at least.

If the face is not detected, whether or not the detecting position flag IO is 1, that is, whether or not the animal body is outside door is determined. (Step S607) When the animal body is outside door, it goes back to Step S601 continues to take an image by camera without special processing, since there is a possibility to image garbage or a bird such as a crow. On the other hand, when the animal body is inside door, there is something to move inside door, so that the unusual state detecting event will trigger. (Step S609)

When the unusual state detecting event triggers, as shown in FIG. 4, a movable crime prevention/security type robot (not shown) takes over a task to confirm a content of the unusual state from the crime prevention/security type robot 1000. The takeover is performed by processing as shown in FIG. 2. The operation of the processing will be described later together with an operation of the takeover to the pet type robot.

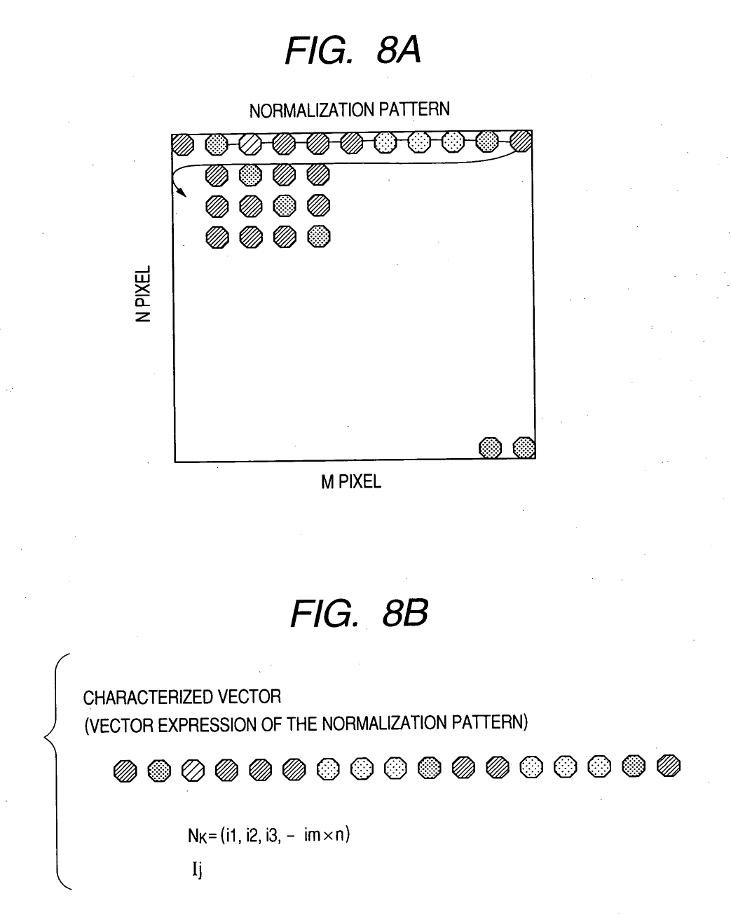

In Step S606, normalization pattern is extracted as shown in FIG. 7D, then, in Step S609, whether or not the extracted face image is a family member is recognized. The recognition will be performed as follows: the normalization pattern of FIG. 7D is a row of the contrasting density (line m×column n) as shown in FIG. 8A. The row of the contrasting density is converted into vector expression as shown in FIG. 8B. The characterized vector Nk (k: a number of normalization pattern acquired from the identical person) uses following calculation.

The characteristic amount using for the recognition is calculated by a relative matrix of the characterized vector and perform KL development.

Formula 1

$$C \cdot \frac{{1}^{r}}{{r}_{K \cdot 1}} \cdot {N}_{k} {N}_{K}^{T}$$

r is a number of normalization pattern acquired from the identical person. Main components (eigen vectors) are acquired by diagonal zing matrix C. m numbers of eigen vectors from the eigen vector having the largest eigen value uses for partial space, and this partial space corresponds to a dictionary for the personal recognition.

In order to perform the personal recognition, it is necessary to register a characterized amount previously extracted together with index information such as ID number of the person and the partial space (eigen value, eigen vector, and number of dimension, and sampling date number). The personal recognition section 109 checks the registered characterized among and a characterized amount extracted from the face image. (Please see JP-A-2001-30065 (FIG. 1)) A name of family member recognized based the result of the check as takeover information is set on FAMILY.

When someone of family member which previously registered checks, then it is necessary to recognize that the family member goes out now or comes home. Therefore, whether or not the position of detecting a face is outdoor or indoor, that is, whether or not the detecting position flag IO is 1 is determined. (Step S610) if the position is outside, determining that the family member comes home and stands outside at entrance so that event which the family member come home triggers. (Step S611) the door is opened to enter the family member into home at the same time to trigger the event. As shown in FIG. 4, the robot 1000 takes over a task to occur the event which the family member comes home.

The processing of the takeover is performed by the processing flow as shown in FIG. 2. As shown in FIG. 4, event is a takeover trigger in case of “family member comes home and meet the family member at door. Therefore, in FIG. 2, the determining result is “Yes” with respect to Step S412, whether or not takeover event occurs, so that the opponent of the takeover is looking for (Step S403) As shown in FIG. 4, the opponent of the takeover is “the pet type robot”, and a communication section 101 looks for the pet type robot. In the embodiment of the invention, since the pet type robot 1001 is near the crime prevention/security type robot 1000 positioned at entrance, the communication section 101 of the pet type robot 1001 connects to the robot 1000 via communication line. Then, whether or not the opponent to take over is correct with each other by each recognition section 107 is recognized. (Step S404) the takeover begins when recognized that the opponent to take over is correct. (Step S405)

In this case, a takeover task “to meet the family member at the door” and personal-recognized family member “to meet who is the family member at the door” determined by a takeover determining section 108 of the crime prevention/security type robot 1000, as a takeover information, are transmitted via communication section 101. For example, in the Step S406, the crime prevention/security type robot 1000 at the entrance converts a content of the takeover information into a voice via media converting section 102. (Step S406)

OTHER, it's SELF. SELF complete a half task. So, OTHER takes over the last half of the task.” Such a template is used to perform the takeover based on the takeover information. SELF or OTHER indicates to use instant names. Thus, nicknames of the robots take over the task are binding. For example, since the crime prevention/security type robot 1000 is SELF, the nickname of the robot 1000 at the entrance “Smith's entrance” is inserted into “SELF”. In OTHER, the nickname of the pet type robot 1001 “John” which successes to communicate with the robot 1000 as a result of the recognition is binding. Since “SELF” is himself, SELF is previously binding. When the takeover begins at Step S405 and the opponent of the takeover is determined, OTHER is binding.

The task is “family member “FAMILY” comes home and to meet “FAMILY” at the door.” A name of the family member detected by the source of the takeover “for example, Father” is blinding in replace for “FAMILY”. As a result of the binding, the template shows as follows:
“OTHER (John), it's “SELF Smith's entrance”. “SELF Smith's entrance” completes a half task (“FAMILY” Father comes home). So, OTHER (John) takes over the last half of the task (to meet Father at the door).”

As a result of the template, OTHER and SELF is deleted from the template as follows;
John, it's Smith's entrance. Smith's entrance completes that Father comes home. So, John takes over to meet Father at the door.” Thus, in this case, the template is exhibited at media generating section 103.

The pet type robot 1001 converts the template at a media converting section 102 on the basis of the takeover information as shown in FIG. 5. For example, “Hi, it's SELF (John). OTHER completes a half task. OTHER takes over the last half task.” As a result of the binding, the template as follows; “Hi, it's SELF (John). OTHER completes a half task (“FAMILY Father comes home.”). OTHER takes over the last half task (to meet “FAMILY” Father at the door).” The media generating section 103 converts the template into voice as follows; “Hi, it's John. OTHER completes that Father comes home. OTHER takes over to meet Father at the door,” and the pet type robot 1001 moves to the entrance by the movable section 110. Whether or not the pet type robot moves to the entrance is determined by the position detecting section 105. Thus, the takeover from “family member comes home” to “to meet the family member at the door” is completed from the crime prevention/security type robot 1000 (Smith's entrance) to the pet type robot 1001 (John).

In case that the detection position flag IO is equal to 0 and the family member inside door goes out home in Step S610, a process Step S612 is performed. Thus, the family member goes out but whether or not someone stays home is determined. If someone is inside door, the event to see the family member off occurs. (Step S613) the takeover of the event to see the family member off is as same as that of the event to meet the family member at the door. Herein, the description will be omitted.

On the other hand, in case that all family members are out and, an event of house-sit occurs before the event to see the family members off. (Step S614) Thus, the house-sit is takeover from the crime prevention/security type robot 1000 to the pet type robot 1001.

In Step S609, in case that a detected face is not one of the family members, it is judged whether or not a face of the robot or a face of the pet is detected. (Step S615). As a result of the judgment, in case that the detected face is not human face, the verified name of the pet or robot is bind with PET. The PET is called to. (Step S616)

In case that a detected face is human face, the detected numbers is set in FC. (Step S617) whether or not the detection position flag IO is equal to 1, that is, whether or not visitors are coming is detected. (Step S620) the detected numbers FC is added to the number of the visitors “VI”. “VI” is available to detect how many visitors are inside door. Then, company event occurs. (Step S622)

On the other hand, if the detection position is inside entrance, it is confirmed that a number of visitors “VI” is larger than a number of people coming home “FC”. If Vi is not larger than FC, an event to detect an unusual state occurs. (Step S623). If VI is larger than FC, VI minuses FC and an event that the visitors come home occurs. (Step S624)

The company event and the event that the visitors come home can be overtake to the pet type robot as well as the event to see family members off and the event to meet the family members at entrance. The events are informed of the family members, and urges the family members to meet someone at the entrance or to see someone off. Further, the pet type robot together with the family members meet someone at the entrance or see someone off. A Processing method with respect to the events is performed by adding/editing the protocol as shown in FIG. 3.

In case that a takeover opponent is not found when the takeover opponent is searched as shown in FIG. 2 (Step S403), the crime prevention/security type robot 1000 is a type of fixed position (Step S410). Accordingly, the robot 1000 stands by (Step S409), and then the takeover opponent is searched again. At this time, it is possible to say “Please wait for a while” by a voice synthesis. It is possible to avoid silence by flowing BGM or executing to exhibit other media. In case that the source of the takeover is a movable type, the source can change its position not to find by others. (Step S411)

In this embodiment, media generating method is voice synthesis. However, the media generating method is not limited in the voice synthesis. For example, in case of a pet type robot with a tail, the takeover can be shown by wagging the tail together with the voice synthesis.

Thus, by the above-construction, it is easy to confirm that the takeover can be performed in safety, so that user has a large feeling of security.

In the first embodiment, the takeover is triggered by an event, but the takeover is not limited in the type. The second embodiment will be described by showing an example in which the takeover is triggered by the position.

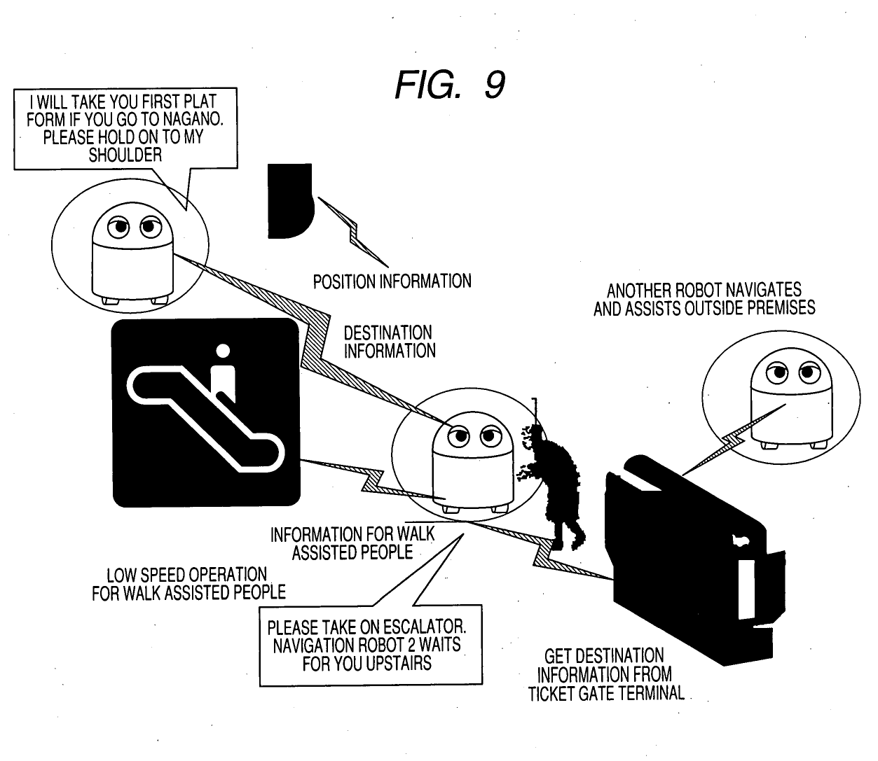

For example, as shown in FIG. 9, between robots which guides within each floor, the takeover is triggered at the position to connect each floor where elevator or steps are provided.

In this case, in flow chart of FIG. 2, in Step S401, whether or not the takeover event occurs is detected, and whether or not takeover position is positioned is detected on the basis of the position detected by position detecting section 105. (Step S402)

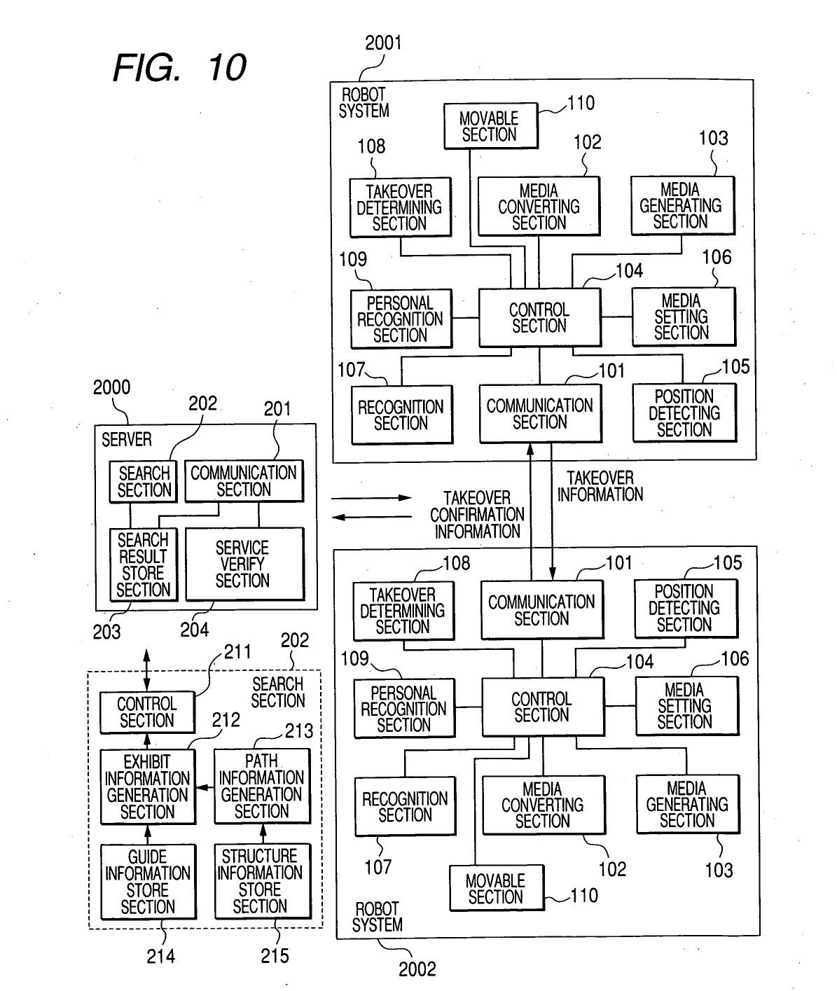

Searching the takeover opponent, verification, and a takeover method in this embodiment is same in case of the event trigger. Further, verify is performed by a ticket or commuter pass which are put in ticket gate, and a guide path is correspondingly generated. The construction of this embodiment is shown in FIG. 10.

Premises map or transfer information, and weather information etc is searched by server 2000. Communication section 101 of a robot system 2001 and 2002 performs communication between the robots. Further, the communication section performs transmitting/receiving, and performs a search of guide paths of the premises and a search of weather in the destination. As a result, for example as shown FIG. 9, the communication section performs to exhibit media for guider.

In FIG. 10, server 2000 generates the premises guide map by following form. The server 2000 is high performance computer. The server 2000 includes a communication section 201 which communicates each robot system, a search section 202, a search result holding section 203, and a service verify section 204. The search section 202 which make premises guide map includes a construction information store section 215 which stores construction information as 3 dimensions information, guide information store section 214 which stores guide information as landmark to find guide point, path information generation section 213 which generates paths connecting start point to goal point from the construction information, exhibit information generation section 212 which extracts the guide information from the guide information store section 214 in accordance with direction of entering into or exiting from the guide point of the generated paths and generates exhibit information to make guide users understood, and control section 211 which controls operation of each section.

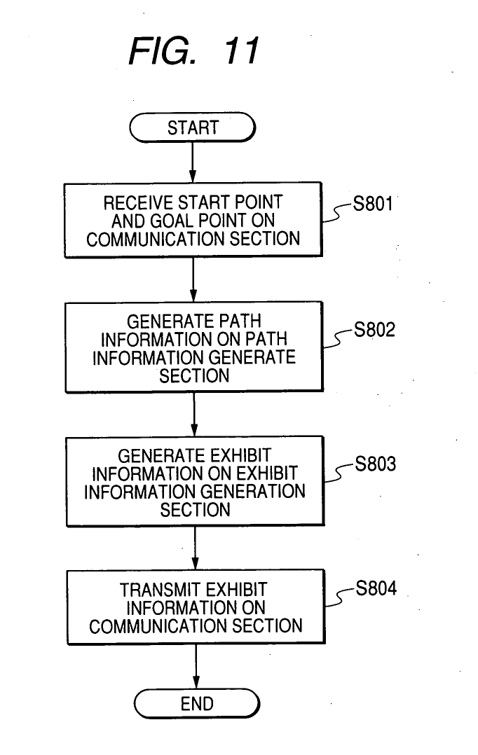

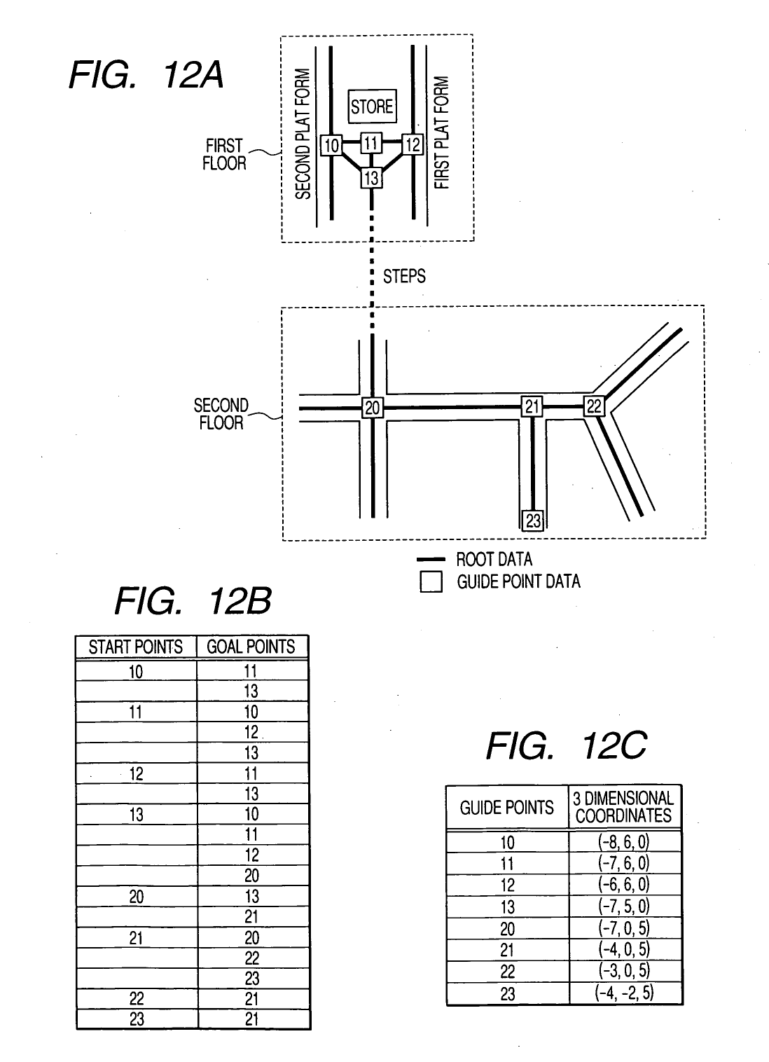

FIG. 11 shows a flow chart of a processing order in the premises guide system. When a robot system transmits start point information and goal point information to the server 2000 via the communication section 11, the servers performs a processing as shown in FIG. 11. The server 2000 receives the start point and the goal point which are transmitted from the robot system 2001 or 2002 on the communication section 21. (Step S801) Then, the path information generation section 213 generates most appropriate path information from the construction information stored in the construction information store section 215. (Step S802) Herein, the construction information includes root data, as shown in FIG. 12A, in which paths from start points to goal points in 3 dimensions construction of the premises are represented by line segments and guide point data which indicates delimiter of the root data. The guide point is mainly set in divide point of the root data and the entrance of the room and is positioned at which the guide user exhibits the premises guide. The root data which forms the construction information is a form of data as shown in FIG. 12B. The guide point data is a form of data as shown in FIG. 12C. The root data and the guide point data are stored in the construction information store section 215.

The path information generation section 213 extracts from the construction information a portion which corresponds to the most appropriate path which connects the start point to the goal point.

Then, the exhibit information generation section 212 extracts from the guide information store section 214 the guide information which corresponds to the generated path information. Herein, the guide information represents landmark data as a landmark of each guide point or landscape data with respect to all entering and exiting directions.

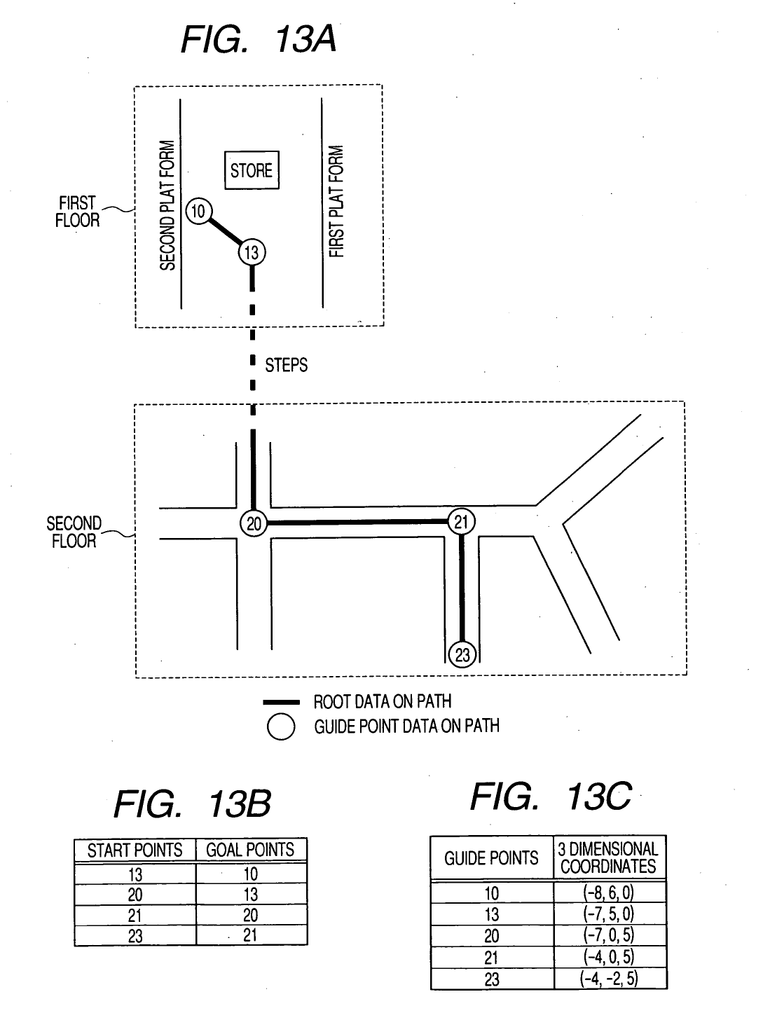

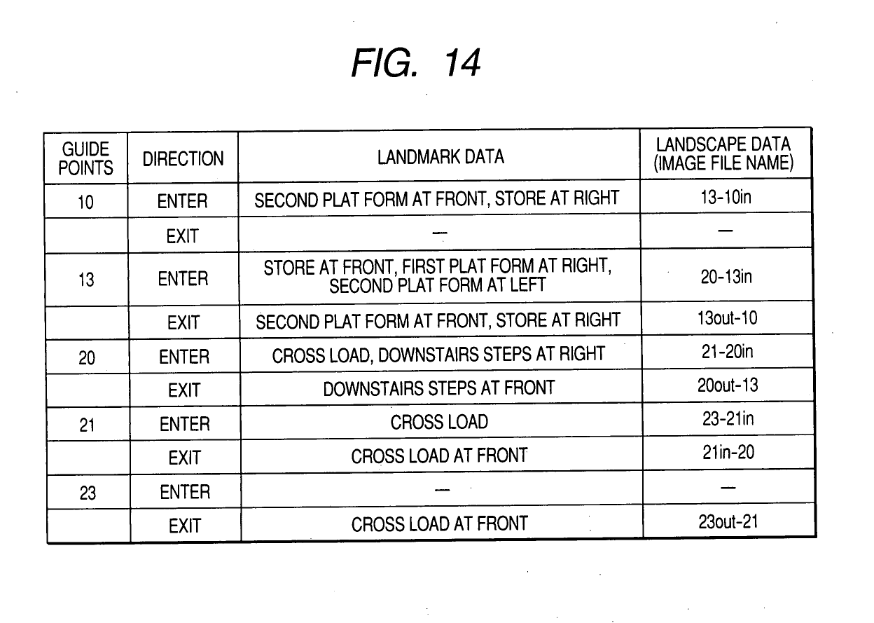

For example, FIG. 14 shows the guide information which corresponds to path information which shows in FIGS. 13B and 13C. Herein, Exit is only way in 23rd guide point as the start point. Accordingly, information of enter is not necessary at the 23rd guide point. In the 10 th guide point as the goal point, information of exit is not necessary.

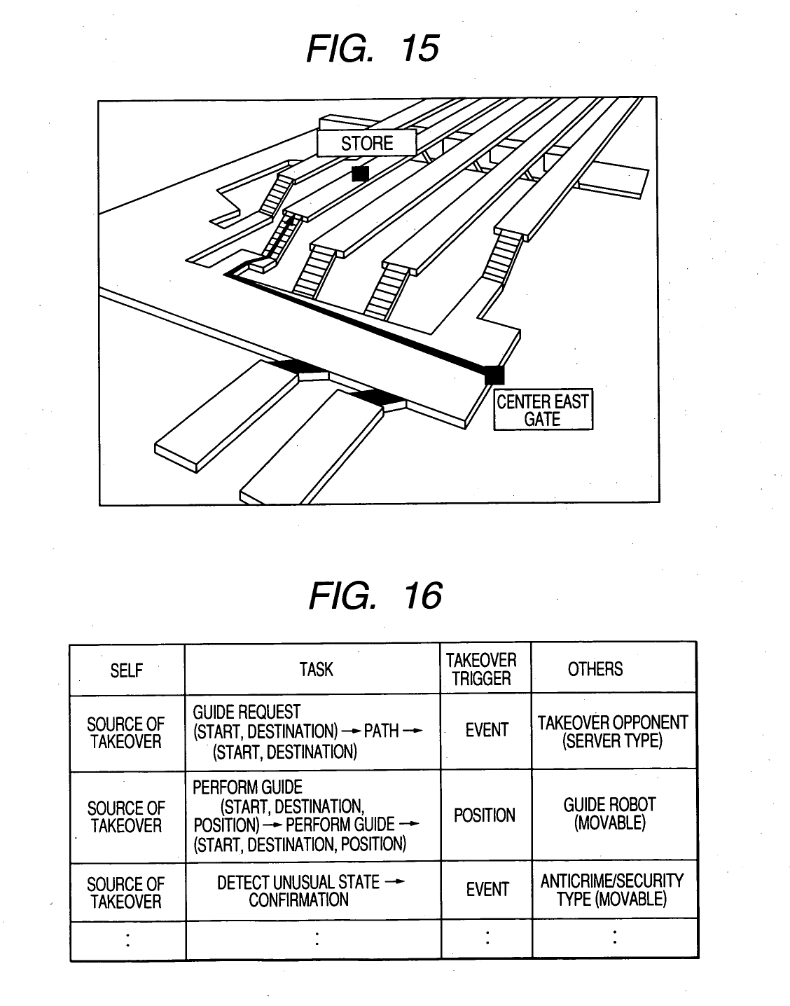

When points such as a border line and a turning point is designated on the basis of plan views of the premises by using an editor, as shown in FIG. 15, path network data is automatically generated and hold in the search result holding section.

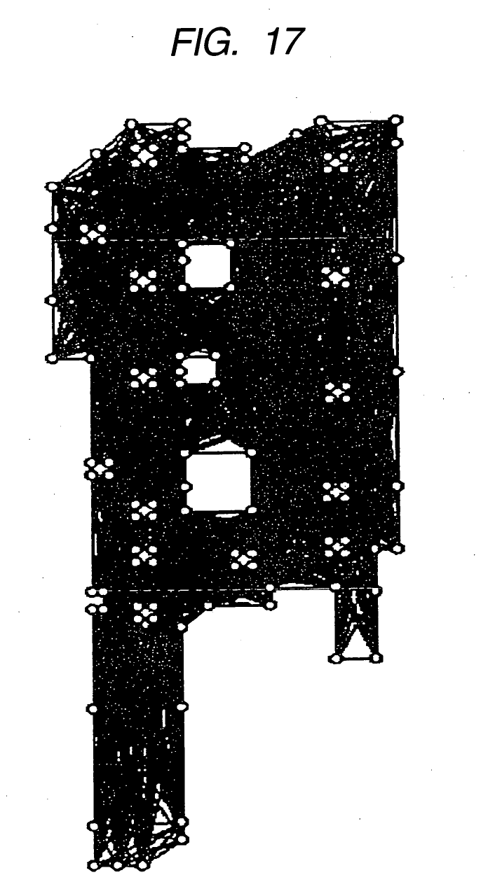

For example, the robot system 2001 stands at the position “CENTER EAST GATE” for guide. “STORE” is a guide point. For example, a takeover protocol of a takeover determining section 108 of the robot system 2001 is a form as shown in FIG. 16. when a task “guide request→path search” occurs, a takeover opponent is a server type. The robot system 2001 stores a path search from “CENTER EAST ENTRANCE” to “STORE” by the search section 202 via communication section 101 and communication section of the server 2000. A path from “CENTER EAST ENTRANCE” to “STORE” is searched from path network data as shown in FIG. 17 and the search result is returned to the robot system 2001.

The robot system 2001 can guide with 3 dimensions map as show in FIG. 17 by using the search result. Further, as shown in FIG. 9, the robot system can guide in accordance with the map and comes to a gate position of an escalator for upstairs, as takeover position, by POSITION on the basis of the takeover protocol as shown in FIG. 16. The takeover occurs by position, the robot system 2001 verifies for the takeover with the robot system 2002 in accordance with the flow chart as shown in FIG. 2. The robot system 2002 takes over a guide as shown in FIG. 9.

By the above construction, the robot systems only move in one plane. It is not necessary to provide large and complex moving section with the robot systems. In view of the search, it is not necessary to provide a server which requires high electric power with the robot systems. Thus, in the invention, the robot system for guiding in the premises can provide information required for guide users accordingly and appropriately. The robot system may be lightness in weight and have long battery life.

1. A cooperative robot system comprising:
a takeover determining section which determines whether or not another robot takes over an executed task;
a communication section which transmits a takeover information to the another robot when the takeover determining section determines to take over the executed task;
a media converting section which converts the takeover information into at least one of linguistic expression and non-linguistic expression;
a media generating section which generates control information which represents a converted result of the media converting section in the linguistic or non-linguistic expression; and
a media setting section which exhibits a takeover content of the takeover information represented in at least one the linguistic expression and the non-linguistic expression.

2. A cooperative robot system according to claim 1, further comprising:
a verify section which verifies whether or not the another robot which takes over the executed task is correct.

3. A cooperative robot system comprising:
a takeover determining section which determines whether or not another robot takes over an executed task;
a communication section which receives a takeover information from the another robot when the takeover determining section determines to take over the executed task;
a media converting section which converts the takeover information into at least one of linguistic expression and non-linguistic expression;
a media generating section which generates control information which represents a converted result of the media converting section in the linguistic or non-linguistic expression; and
a media setting section which exhibits a takeover content of the takeover information represented in at least one the linguistic expression and the non-linguistic expression.

4. A cooperative robot system configured by plural robots comprising:
a first robot system including;
a takeover determining section which determines whether or not another robot takes over an executed task;
a communication section which transmits a takeover information to the another robot when the takeover determining section determines to take over the executed task;
a media converting section which converts the takeover information into at least one of linguistic expression and non-linguistic expression;
a media generating section which generates control information which represents a converted result of the media converting section in the linguistic or non-linguistic expression; and
a media setting section which exhibits a takeover content of the takeover information represented in at least one the linguistic expression and the non-linguistic expression; and
a second cooperative robot system including;
a takeover determining section which determines whether or not another robot takes over an executed task;
a communication section which receives a takeover information from the another robot when the takeover determining section determines to take over the executed task;
a media converting section which converts the takeover information into at least one of linguistic expression and non-linguistic expression;
a media generating section which generates control information which represents a converted result of the media converting section in the linguistic or non-linguistic expression; and
a media setting section which exhibits a takeover content of the takeover information represented in at least one the linguistic expression and the non-linguistic expression.

5. A cooperative robot system according to claim 4, further comprising:
a server including;
a communication section which communicates verify information with the robots; and
a search section which searches guide information on the basis of the verify information.

6. A navigation robot comprising:
a position information providing section which provides a position information;
a communication section which communicates with a part of area in which a communication can be performed;
a user information store section which stores an information including a destination of user to be navigated which is received from the area;
a search section which searches a content stored in the user information store section;
a media converting section which converts a search result of the search section into at least one of linguistic expression and non-linguistic expression; and
a media setting section which exhibits a converted result of the media converting section, wherein
the navigation robot exhibits guide relation information with the user to be navigated.

7. A navigation robot according to claim 6, further comprising:
a determining section which determines whether or not a present position is a takeover position of at lease one of a navigation and walking assist on the basis of the position information acquired from the position information providing section; and
a takeover confirmation section which confirms via the communication section whether or not at least one among another navigation robot, an elevator, and an escalator as an takeover opponent can take over when the present position is the takeover position, wherein
the navigation robot transmits the user information stored in the user information store section via the communication section and exhibits an information including navigation information with the user to be navigated when the takeover confirmation section confirms that the at least one among the another navigation robot, an elevator, and an escalator can take over.
